(19) United States
(12) Patent Application Publication
(10) Pub. No.: US 2021/0319313 A1
(43) Pub. Date: Oct. 14, 2021

(54) DEEP REINFORCEMENT LEARNING METHOD FOR GENERATION OF ENVIRONMENTAL FEATURES FOR VULNERABILITY ANALYSIS AND IMPROVED PERFORMANCE OF COMPUTER VISION SYSTEMS

(71) Applicant: HRL Laboratories, LLC, Malibu, CA (US)

(72) Inventors: Michael A. Warren, Northridge, CA (US); Christopher Serrano, Whittier, CA (US)

(21) Appl. No.: 17/115,646

(22) Filed: Dec. 8, 2020

Related U.S. Application Data
(60) Provisional application No. 63/007,848, filed on Apr. 9, 2020.

(51) Int. Cl. G06N 3/08; G06N 3/04

(52) U.S. Cl. CPC G06N 3/08; G06N 3/0445

(57) ABSTRACT

Described is a system for generating environmental features using deep reinforcement learning. The system receives a policy network architecture, initialization parameters, and a simulation environment that models a trajectory of a target system through a physical environment. Landmark features sampled from the policy network are initialized, and a trained policy network is generated by training the policy network using a reinforcement learning algorithm. A set of environmental features are generated using the trained policy network and displayed on a display device.

### CROSS-REFERENCE TO RELATED APPLICATIONS

This is a Non-Provisional Application of U.S. Provisional Patent Application No. 63/007,848, filed Apr. 9, 2020, entitled, “A Deep Reinforcement Learning Method for Automatic Generation of Environmental Features Causing a Neural Network Based Vision System to Produce Incorrect Estimates”, the entirety of which is incorporated herein by reference.

### BACKGROUND OF INVENTION

### (1) Field of Invention

The present invention relates to a system for improving neural network based computer vision and, more particularly, to a system for improving neural network based computer vision using deep reinforcement learning for automatic generation of environmental features to be used in connection with vulnerability analysis or general performance improvement.

### (2) Description of Related Art

Most real-world applications of artificial intelligence (AI), including autonomous systems, anomaly detection, and speech processing, operate in the temporal domain. However, nearly all state-of-the-art adversarial attacks are carried out statically (i.e., the attack algorithm operates entirely on fixed, static inputs). Neural network-based vision systems are known to be susceptible to so-called adversarial attacks. At a high level, such an attack attempts to discover input images that would not be misclassified (or otherwise misperceived) by a human observer but are misclassified by the neural network. Discovering such adversarial examples turns out to be reasonably straightforward, even in cases where the examples generated are required to satisfy additional constraints. What is not straightforward is the design of adversarial examples that can be realized in the real world.

There are several factors that make transfer to the real world a non-trivial challenge. First, many of the existing attacks only work under restrictive lighting and viewing conditions. Second, existing attacks ignore the fact that, in the real world, such systems are operating in time. Finally, the existing state-of-the-art approaches (such as that described by Sharif et al. in “A General Framework for Adversarial Examples with Objectives,” ACM Transactions on Privacy and Security, 1-30, 2019, hereinafter referred to as “Sharif et al.”, which is hereby incorporated by reference as though fully set forth herein) assume white-box access to the target system (i.e., they assume access to underlying source code of the neural network based algorithms).

The current state-of-the-art in terms of uncontrolled real-world attacks is the recent work of Sharif et al., which makes use of generative models. However, their work focuses on the production of “adversarial eyeglasses” that would fool a face recognition system and is, crucially, a white-box attack. As described above, a white-box attack is one in which the attacker has access to the model's parameters. In a black box attack, the attacker has no access to these parameters. In other words, a black box attack uses a different model, or no model at all, to generate adversarial images. From the perspective of vulnerability analysis or design to improve performance, the white box assumption is not always reasonable. Therefore, it is useful to develop approaches that can dispense with this assumption.

Serrano, C. R., Sylla, P., Gao, S., & Warren, M. A. in “RTA3: A real time adversarial attack on recurrent neural networks”, Deep Learning Security 2020, IEEE Security & Privacy Workshops, hereinafter referred to as Serrano et al., (which is hereby incorporated by reference as though fully set forth herein) describes targeting recurrent neural networks (RNNs) or stateful systems; however, their work only enabled controlled attacks. As described in Serrano et al., in a controlled attack, the attacker is able to manipulate some facet of the input signal or environment dynamically. In an uncontrolled attack, only prior one-time manipulation (e.g., of the environment) is allowed.

Thus, a continuing need exists for systems for carrying out real world vulnerability analysis on neural network-based computer vision systems and generating object designs that improve performance by such vision systems in the uncontrolled black box setting.

### SUMMARY OF INVENTION

The present invention relates to a system for improving neural network based computer vision and, more particularly, to a system for improving neural network based computer vision using deep reinforcement learning for automatic generation of environmental features to be used in connection with vulnerability analysis or general performance improvement. The system comprises one or more processors and a non-transitory computer-readable medium having executable instructions encoded thereon such that when executed, the one or more processors perform multiple operations. The system receives, as input, a policy network architecture, initialization parameters, and a simulation environment that models a trajectory of a target system through a physical environment. A set of landmark features sampled from the policy network is initialized. A trained policy network is generated by training the policy network using a reinforcement learning algorithm. A set of environmental features is generated using the trained policy network and displayed on a display device.

In another aspect, the set of environmental features affects performance of a task by a machine learning perception system.

In another aspect, the machine learning perception system employs a recurrent neural network (RNN).

In another aspect, one or more generative models is trained.

In another aspect, the task performed is selected from a group consisting of detection, classification, tracking, segmentation, textual analysis, and anomaly detection.

In another aspect, the system causes physical realization of the set of environmental features by an apparatus.

In another aspect, the apparatus is a printer.

In another aspect, the target system is an autonomous vehicle.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of a system for improving neural network based computer vision according to some embodiments of the present disclosure;

FIG. 2 is an illustration of a computer program product according to some embodiments of the present disclosure;

FIG. 3 illustrates a high-level overview of a procedure for a pre-trained case according to some embodiments of the present disclosure;

FIG. 4 illustrates a detailed summary of a pre-trained case according to some embodiments of the present disclosure;

FIG. 5 illustrates a high-level overview of a procedure for a general case according to some embodiments of the present disclosure; and

FIG. 6 illustrates a detailed summary of a general case according to some embodiments of the present disclosure.

### DETAILED DESCRIPTION

The present invention relates to a system for improving neural network based computer vision and, more particularly, to a system for improving neural network based computer vision using deep reinforcement learning for automatic generation of environmental features to be used in connection with vulnerability analysis or general performance improvement. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

(1) Principal Aspects

Various embodiments of the invention include three “principal” aspects. The first is a system for improving neural network-based computer vision. The system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

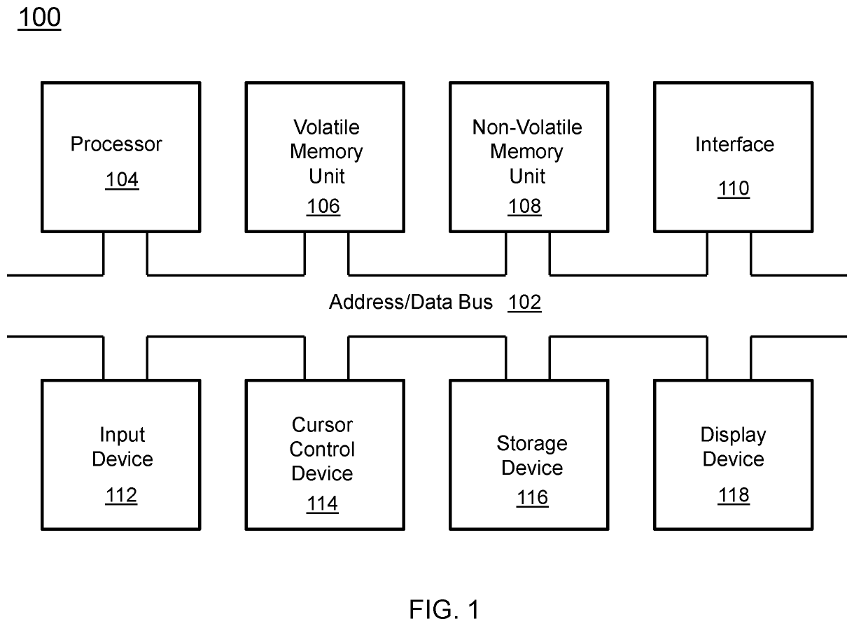

A block diagram depicting an example of a system (i.e., computer system 100) of the present invention is provided in FIG. 1. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA).

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 104. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 104. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

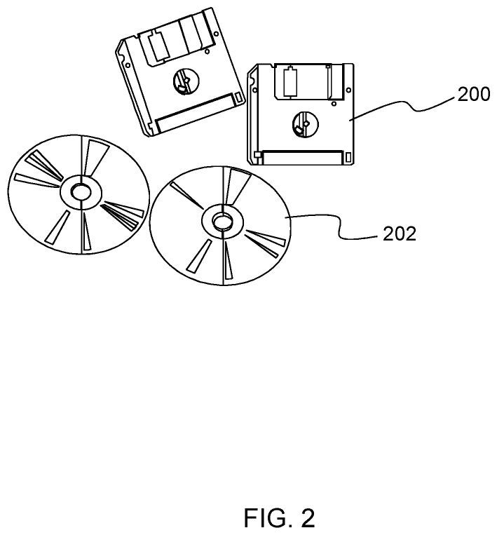

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e.

computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

(2) Specific Details of Various Embodiments

The present invention relates to a system and method which is configured to (1) carry out security vulnerability analysis on neural network-based computer vision systems; and/or (2) automatically generate object designs that will enhance the performance of a neural network-based computer vision system. The outputs of the system and method according to embodiments of the present disclosure are designs (e.g., stickers, road marking patterns, posters) which impact the performance of a computer vision system. Below such designs are referred to as environmental features. In the case of the vulnerability analysis use-case, the designs are constructed so as to negatively impact the performance of the computer vision system. For an end-user, such as an autonomous vehicle company, the invention described herein is useful for identifying potential security vulnerabilities in the autonomous vehicle that could be exploited by bad actors. In the case of object design, the invention described herein could be used by, for instance, urban planners to produce new designs for signs or road markings that would be more easily identified by neural network based computer vision systems, or for clothing manufacturers to design clothing patterns that would make the wearer easier for computer vision systems to correctly detect (e.g., to be worn when cycling or jogging).

Described herein is a method that can be used for either vulnerability analysis of a neural network-based computer vision system or generation of designs enhancing the performance of a computer vision system. The focus in the exposition below is on the former, since the latter can be realized, as will be clear to one skilled in the art, by simply replacing cases in the exposition below where performance is to be degraded with the corresponding requirements (e.g., via change of reward functions) that the performance should be enhanced. This method combines deep reinforcement learning (RL) and generative models in a unique way, for uncovering potential real-world threats to a machine learning based perception system that employs a recurrent neural network (RNN) based or other stateful (i.e., possessing a memory of some kind) vision system. The combination of reinforcement learning and generative models in an adversarial attack in this way is unique. Reinforcement learning has been used together with generative models in the context of “imitation learning”, where one has expert generated data that one wishes to train a controller to mimic. For example, the expert generated data can be an expert driver's steering and throttle data. In this case, the generative model is used to generate fake expert data with which to augment training of the controller. In prior art, a generative model is used to generate data that was used to train the reinforcement learning agent, whereas in the present invention, the reinforcement learning agent is the generator of the generative model.

In addition, reinforcement learning is mostly concerned with control and planning applications. In the usual procedure for training a generative model it is necessary to be able to calculate gradients of a neural network classifier f. In the present invention, f corresponds to the black-box target system and, therefore, these gradients cannot be calculated. The unique use of reinforcement learning is what allows training of the generator component without access to these gradients in the invention described herein. In what follows, the invention may be referred to as an “attack”, but this is merely in keeping with the standard academic terminology. Indeed, the invention could be used as one component of an actual defense against potential bad actors.

Nearly all of the state-of-the-art work on real world adversarial attacks is in the white-box context in which the internals of the system being targeted (henceforth, the target system) are known to the attacker. Previous work disclosed in Serrano et al. improves on this by enabling real-time black-box attacks through the use of reinforcement learning (which allows one to avoid having to back-propagate gradients through the target system). However, to be effective, that work must be carried out in real time in the sense that the attacker must be able to manipulate the input signal to the target system either continuously or periodically in a dynamic way. Such an attack is referred to as a controlled attack. An example of such a controlled attack would be given by the case in which an attacker drives in front of a target system (e.g., an autonomous car that uses a neural network-based computer vision system) and displays dynamically updating images on a tablet. For the purposes of this disclosure, an attack is any adversary who might want to exploit vulnerabilities in the system. For instance, an autonomous vehicle manufacturer can utilize the invention described herein to identify potential vulnerabilities in autonomous vehicles before the vehicle is released to the public so that the potential vulnerabilities can be fixed (i.e., before hackers can cause their autonomous vehicles to crash by putting stickers on billboards.)

The present invention presents a significant advantage over the state-of-the-art by enabling uncontrolled black-box attacks. In these attacks, the attacker is only able to alter certain aspects of the environment in which the target system will be deployed one time prior to the deployment of the target system in the environment. In a black-box attack, details of the internals of the target system are not required, which makes the attacks more likely to transfer to unseen systems. For instance, this could be realized by the attacker altering the appearance of fixed billboards along a fixed stretch of highway that the target system will travel. The purpose of an attacker altering a billboard appearance is to cause an autonomous vehicle to crash or misbehave in some way. That is, the alterations of the environment that the attacker is able to affect are entirely static. This improves on the existing work in that it is both uncontrolled and black-box.

The unique combination of using reinforcement learning together with a generative model presents a non-trivial extension of earlier work by Serrano et al. As described above, generative models are typically used in perception applications whereas reinforcement learning (RL) (and, therefore, policy networks) are used in control/planning. For those, respective, applications, there is no need to combine the two. In particular, the idea to take the policy network of the reinforcement learning agent to be the generator of the generative model is a largely unexplored application. The closest work to this is Ho and Ermon in “Generative Adversarial Imitation Learning”, NIPS, pp. 4565-4573, 2016, which is hereby incorporated by reference as though fully set forth herein, but in their work, the problem was entirely different (i.e., training a policy from expert examples, which is a straightforward extensions of the usual application of generative adversarial networks) and was completely unrelated to the problem of attacking a vision system.

The following assumptions are made in regards to the attack model that the invention described herein addresses.

1. There is a fixed perception or other data processing system, referred to as the target system, that uses a recurrent neural network (RNN) or other memory-based architecture.

2. The target system will be deployed on a platform that operates in time along a roughly fixed trajectory in a fixed operating environment (the fixed trajectory can be modeled as a stochastic process with a specified distribution) (e.g., in the case of a vehicle, this could mean that the target system travels on a vehicle following a fixed route with some additive gaussian noise in speed and steering). 3. There is a finite set L={ [symbol] ₁, . . . , [symbol] ₙ} of features of the operating environment, referred to as landmarks, distributed along the route and perceptible to the target system. 4. An attack consists of alterations of the features of the landmarks. 5. An attacker is allowed to carry out the attack exactly one time. 6. The attacker's goal is to cause the target system to generate incorrect outputs over as large a subset of the route as possible.

7. The attacker has advanced knowledge of the operating environment and is capable of producing a reasonably high-fidelity recreation of the operating environment in a simulation. 8. The attacker has black-box access to the target system and is capable of integrating the target system in the loop with the simulation system.

There is a relaxed version of this model in which the attacker also controls the positions of (alternatively, approximately at what time) the landmarks (are encountered) along the trajectories. This case is, in fact, easier than the current case and, therefore, the case in which the positions (either physically or in time) are constrained is described.

The invention described herein makes use of several crucial observations. First, one of the crucial observations that was made and exploited in previous work (described in Serrano et al.) is that, when attacking a stateful target system, it is possible to progressively push the memory into worse and worse states using periodic (as opposed to continuous) attacks. The memory is the state present in the neural network-based computer vision system. The memory is typically used for tracking, as it is easier to predict where a moving object will be in the next frame if one is paying attention to where it has been in the past. Second, in the uncontrolled case the attacker has advanced knowledge of the environment in which the attack is to be carried out. Therefore, it is assumed that the attacker is capable of creating a simulation environment using common simulation tools (e.g., the Unreal game engine developed by Epic Games located at 620 Crossroads Blvd., Cary, N.C.). Indeed, many autonomous vehicle researchers and manufacturers make extensive use of simulation tools during the development and testing of these systems, so it is reasonable to also allow the attacker use of analogous tools. This is particularly true, given that the use of the invention is anticipated by manufacturers in order to identify potential system weaknesses/attack vectors. Finally, the use of generative models, such as generative adversarial networks (GANs enables the automatic generation of realistic (and, therefore, difficult to detect) design of landmark features that can then be pushed to result in incurred operation of the target system. These observations were combined to yield the system described herein, as detailed below.

Let Fᵢ denote a set of features, specified by the user, of landmark [symbol] ᵢ. The features in these sets are referred to as “admissible features”. Intuitively, the admissible features capture some restrictions, such as ruling out random noise, or imposing some aesthetic constraints on the appearances of landmarks. For example, in the case where the attacker is interested in altering fixed billboards (landmark), this might be some space of graffiti patterns (features) that could be placed over the billboards. Given suitable data corresponding to samples from the spaces Fᵢ, it is possible to train generative models gᵢ: Zᵢ→Fᵢ from latent spaces Zᵢ. Given such models gᵢ it suffices, in order to obtain an uncontrolled attack, to find an element in the set Z:=Πᵢ₌₁ⁿZᵢ. This is the starting point for the attack according to the invention. Two versions of the attack are considered. In the first version, which is easier, it is assumed that the generative models gᵢ are given. In the second version, the generative model will be trained in the loop with the attack.

(2.1) Pre-Trained Case

In the first case, referred to as the Pre-Trained Case, trained generative models gᵢ are given, and the aim is to carry out the attack. This is formulated as a problem that can be solved in the setting of reinforcement learning (albeit a somewhat unusual form). To formulate this as a reinforcement learning problem, define a state (or observation) space S which captures the (relevant) state of the scenario and an action space A corresponding to the actions that can be selected (in this case, by the attacker). Finally, there must be some kind of transition dynamics that govern the evolution of the scenario, and a reward signal that provides feedback regarding the performance of the agent/policy π that is being trained to select actions from A.

In the present disclosure, an observation (or state) consists of a subset s of the set L of landmarks (i.e., the set S is the set of subsets of L). Intuitively, s is the set of landmarks that the target system has previously seen/encountered (during the current simulation run and including those landmarks currently being perceived by the target system). The action space in this version of the attack is the set Z defined above. When an action a is taken in state s, only those landmarks lᵢ that are not in s are affected. That is, an agent can only effectively update the features of landmarks that have not yet been encountered by the target system. The additional dynamics of the system are governed by the simulation (or hardware-in-the-loop simulation setup). The use of a reinforcement learning agent to identify a point of the latent space of a generative model was exploited for point cloud reconstruction in Sarmad et al. in “RL-GAN-Net: A Reinforcement Learning Agent Controlled GAN Network for Real-Time Point Cloud Space Completion. CVPR, IEEE, pp. 5891-5900, 2019, which is hereby incorporated by reference as though fully set forth herein.

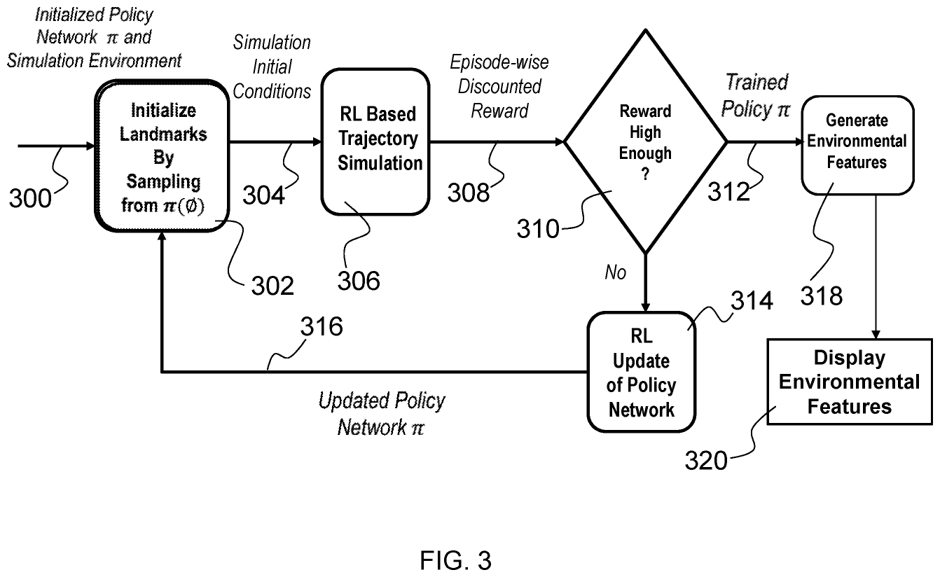

The policy defined for the present invention uses any standard reinforcement learning algorithm to learn parameters of probability distributions over the action space. The training procedure is summarized in FIG. 3. The inputs of this procedure are as follows:

1. A (randomly) initialized neural network π that is referred to as the policy network, which has as inputs the current state and as outputs the parameters of a probability distribution on the latent space Z from above.

2. A simulation environment and simulation scenario that models the trajectories of the target system through the fixed operating environment.

3. The generative models gᵢ from above.

4. A reinforcement learning algorithm for training π

5. A loss function J(-, -) that measures the performance of the target system.

6. Any additional hyperparameters required by the RL algorithm in Step 4 above.

As depicted in FIG. 3, following initialization with the policy network π and simulation environment (element 300), the procedure repeats by initializing the landmarks to features sampled from π (ø) (element 302) using the generative models gᵢ, where ø denotes the empty set as usual, resulting in simulation initial conditions (element 304). A RL based trajectory simulation (element 306) is run which follows the standard (observation, action, reward, update) procedure. In this case, an episode-wise discounted reward (element 308) rⱼ at each step j is defined by:

rⱼ:=J(ŷⱼ, yⱼ),

where ŷⱼ is the estimate of the target system and yⱼ is the (in-simulation) ground truth value at the current step. Thus, the policy network effectively searches the latent space Z for a point that maximizes the deviation between the actual (ground truth) values and target system estimates. A determination is made regarding whether the reward is high enough (element 310). If the reward is high enough, the output is a trained policy π (element 312). The procedure either halts when, as in FIG. 3, discounted rewards reach a sufficiently high level, or when a fixed upper bound on steps is reached. If the discounted rewards do not reach a sufficiently high level, an RL update of the policy network (element 314) is run, resulting in an updated policy network π (element 316).

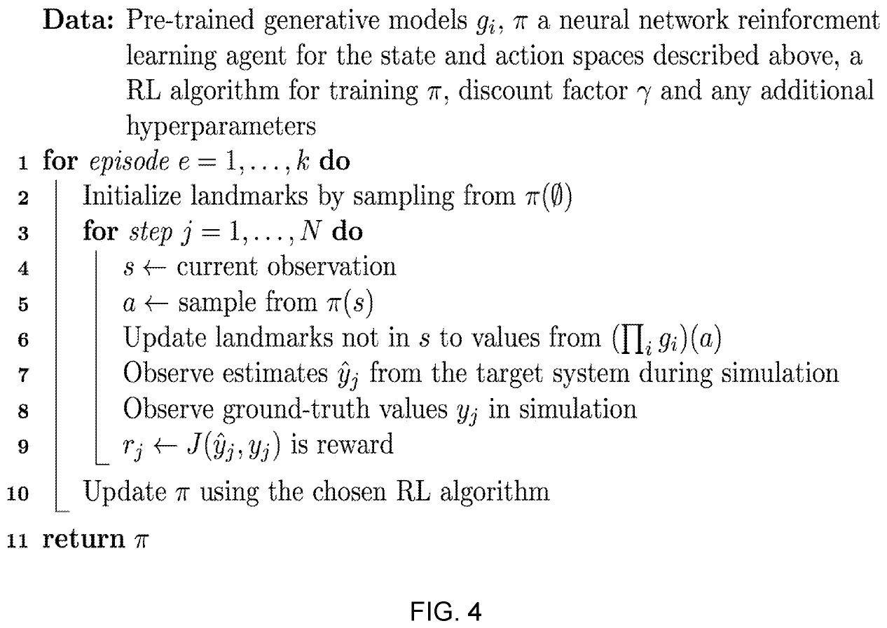

The procedure is summarized in more detail in FIG. 4. Once the policy network has been trained and tested in simulation to a sufficient level of performance, it is necessary to select an actual value of the features using the policy before producing the corresponding real-world features. To this end, a fixed value v, such as the mean μ, should be sampled from the distribution π(ø) as a fixed attack. Then, multiple simulation runs are tested on with this fixed value to ensure that it is sufficiently performant before generating the actual real-world features. Once sufficient performance for the fixed value has been demonstrated in simulation, the values of the landmark features from (Πᵢgᵢ) (v), where Πᵢgᵢ denotes the mapping from the joint latent space to the spaces of landmark features, can be transformed into actual real-world features and placed in the actual operating environment. Πᵢgᵢ is the mathematical notation for the map that takes points in the joint latent space of the generative models gᵢ and produces an image. Non-limiting examples of features include patterns printed as stickers, posters, or stencils, and objects that are three-dimensionally (3D) printed. In the case of clothing design, the features can be turned into silk screen designs that can be applied to clothing.

(2.2) General Case

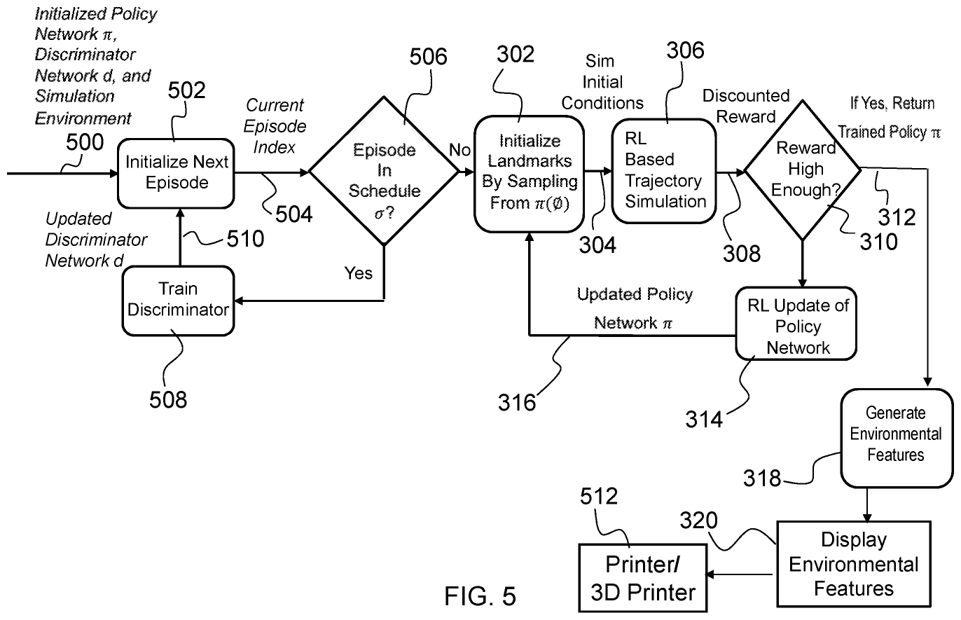

In the case where the generative models are not pre-trained, referred to as the General Case, the reinforcement learning setup is altered slightly. Namely, in this version of the attack, both the generative models gᵢ and the policy network π are trained together. In fact, they are combined by making the policy network π itself the generator of a generative model. The state space remains as above, but the action space is now the space F :=Πᵢ₌₁ⁿ Fᵢ of landmark features itself. The training procedure is summarized in FIG. 5. The inputs of this procedure are as follows:

1. A (randomly) initialized neural network π that is referred to as the policy network which has as inputs the current state and as outputs the parameters of a probability distribution on the space of landmark features F from above.

2. A (randomly) initialized neural network d that is referred to as the discriminator network which has as inputs landmark features and as outputs values in the interval (0,1].

3. A simulation environment and simulation scenario that models the trajectories of the target system through the fixed operating environment.

4. A reinforcement learning algorithm for training

5. A training algorithm for training the discriminator (e.g., see Goodfellow et al., Generative Adversarial Networks, NIPS, 2014, which is hereby incorporated by reference as though fully set forth herein).

6. A loss function J(-, -) that measures the performance of the target system.

7. A schedule a that indicates at which stages to train the discriminator.

8. A data set of genuine features for the landmarks that can be used to train the discriminator.

9. Any additional hyperparameters required by the RL algorithm in Step 4 or the generative training algorithm in Step 5 above.

As indicated in Step 5, it is assumed that training of the discriminator follows a fixed algorithm such as the one from Goodfellow et al., which aims to maximize

Π_{x˜real}[log d(x)]+ε_{x˜π}[log(1−d(x))].

In particular, the intuitive meaning of d(x) is the probability that x is a genuine feature as opposed to a generated/fake one. The novelty here is that the generator is given by a reinforcement learning agent and, as such, the reward signal has to be modified accordingly. In particular, the reward signal is altered as:

rⱼ:=J(ŷⱼ, yⱼ)+log d(αⱼ)

where αⱼ is the action sampled from the policy π at stage j.

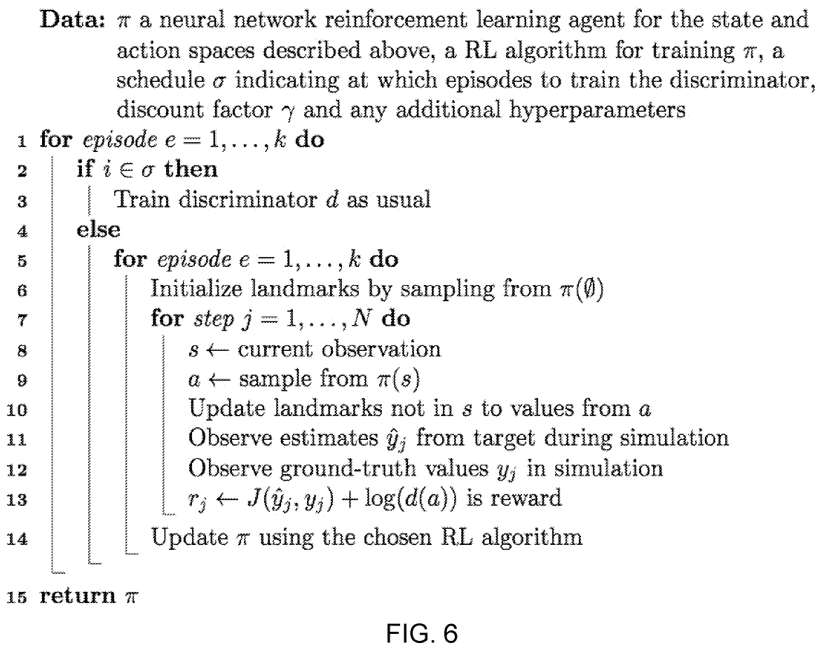

FIG. 5 illustrates a high-level overview of the procedure for the General Case. As described above, the input of the initialized policy network π, the Discriminator Network d, and the simulation environment (element 500) is used to initialize the next episode (element 502). The current episode index (element 504) is used to determine if the episode is in schedule a (element 506). If yes, the episode is used to train the Discriminator Network (element 508), resulting in an updated Discriminator Network d (element 510), which is used in initializing the next episode (element 502). If the current episode is not in the schedule σ, landmarks are initialized by sampling from π(0) (element 302), and the procedure continues as depicted in FIG. 3 for the Pre-Trained Case. The procedure is summarized in more detail in FIG. 6. Once the policy it has been sufficiently trained (trained policy (element 312)), the same procedure as for the Pre-Trained Case described above can be carried out to obtain physical realizations of the landscape features.

Referring back to FIGS. 3 and 5, the trained policy (element 312) allows one to generate environmental features (element 318), or designs, for all of the landmarks by simply evaluating π(ø). The generated environmental features (element 318) are displayed (element 320) on a display device (element 118) (e.g., computer monitor, mobile device screen) and can be used to alter an operating environment during simulation mode, such that a simulation task performed on the operating environment by a machine learning perception system is positively or negatively impacted. In one embodiment, following generation of and display of the generated environmental features (e.g., design, pattern) (element 320), the environmental features are transmitted to an apparatus for physically realizing the designs, such as a printer or 3D printer (element 512). The physical realizations can then be placed in a physical (real-world) environment (e.g., city, street, person on a street) or used as needed. For example, a user of the system described herein can fabricate and affix the fabricated (e.g., printed) environmental features to road signs or clothing.

Finally, for one skilled in the art, this invention can be reduced to practice by following the procedures mentioned above. For instance, one can easily reduce this to practice utilizing standard machine learning tools and a game engine or simulator. In one embodiment of the invention, it is limited to a subcomponent of a system which (a) generates features of actual objects in a fixed operating environment and (b) consumes outputs of runs of a target system through a simulation of the fixed operating environment such that the target system itself is a recurrent neural network or similar stateful (i.e., possessing memory) machine learning system together with their (in-simulation) ground truth values. One non-limiting example of a case in which the invention is applicable is a system for identifying designs that can be affixed to fixed billboards along a fixed route in order to cause a target computer vision system to produce incorrect estimates of the positions of the lane markings on the road relative to the vehicle on which the target computer vision system is deployed. In vulnerability analysis, the invention described herein can be utilized by a manufacturer of self-driving vehicles to ensure that bad actors cannot easily cause their self-driving vehicles to fail to correctly estimate the positions of lane markings. Another example for application of the invention described herein is a system for identifying patterns that can be painted on the roofs of buildings in order to cause a target ISR (intelligence, surveillance, reconnaissance) system deployed on a drone to make incorrect estimates (e.g., for activity recognition or target tracking). For vehicle manufacturers exploring the use of a recurrent neural network (RNN) or other stateful computer vision systems, anomaly detection, and system health monitoring, the present invention could be utilized to detect cases in which such systems could be attacked by a bad actor or might exhibit failures of robustness, which would result in significantly more robust systems.

One purpose of the invention described herein is to be used during system development and/or testing in order to identify possible vulnerabilities. It can be used purely in simulation or as part of real-world (i.e., test track) testing. In one embodiment, the system according to embodiments of this disclosure is used to detect possible vulnerabilities of a system to attacks. In this example, the invention would be used in simulation (ideally as part of a hardware-in-the-loop simulation setup) or a test to provide these kinds of outputs (i.e., vulnerabilities detected vs. vulnerabilities not detected). This is analogous to the use of many malware detection or code analysis tools in that it aims to identify potential vulnerabilities without providing any guarantee of coverage (i.e., just because this method fails to find a vulnerability does not mean that one does not exist, which is also true of malware detection systems). Referring to FIGS. 3 and 5, if the reward is high enough (element 310), it indicates that a potential vulnerability has been identified. The potential vulnerability can then be evaluated by producing the environmental features (element 318) generated by the trained policy (element 312) and carrying out real world testing.

Additionally, the present invention can be used to design features in the environment that would improve the behavior of targeted autonomous systems in the physical environment. For instance, the system described herein can be used to modify the designs of lane markings to improve their correct detection by machine learning vision systems. The goal of the optimization procedure, which is generating the trained policy (element 312), in this use case is to generate (via the trained policy (element 312)) environmental features (element 318), or designs, that would improve the estimates. For instance, in the example of trying to design clothing to improve pedestrian detection, the output of the trained policy (element 312) is a pattern (i.e., environmental features (element 318) to be silk screened onto the article of clothing). Furthermore, the designs of street signs could be modified by the invention described herein to improve their correct classification by machine learning vision systems. In addition, the present invention could be used to modify the design of a jacket to make wearers more easily detected as pedestrians by machine learning vision systems.

In another embodiment, given a RNN, or other stateful/memory-based machine learning system f, that produces a prediction or estimate on the basis of input sensor readings (e.g., images, frames of video, LIDAR point clouds, radar tracks) along an approximately fixed trajectory in a fixed operating environment (e.g., a fixed stretch of highway, fixed road intersection), the invention described herein automatically generates features in the operating environment using deep reinforcement learning to train a generative model capable of such feature generation in such a way as to positively or negatively impact the accuracy of the predictions/estimates produced by f such that, for example, the source code of f is not available; f, or a sufficiently close system, can be queried and integrated in a simulation environment; and/or the fixed operating environment cannot be dynamically altered.

In a desired application of generating an improved clothing design is to aid pedestrian detection. One would like this effect to hold for a variety of perception systems on autonomous cars produced by different vendors, and it would not be possible to obtain the source code of the perception systems for different vendors. In a clothing scenario, a user of the invention described herein could use either one or more surrogate machine learning systems or could carry out hardware-in-the-loop evaluation. In this case, the source code would still not be required, but access to the physical vehicles would be required.

In yet another embodiment, the present invention is a process for statically altering features of an operating environment using a generative model that was trained using deep reinforcement learning in a constrained way (e.g., to avoid detection) in such a way as to negatively impact the performance of a neural network based system for video analysis (e.g., object tracking, object detection, estimation of physical relationships between objects in a scene, activity recognition, segmentation); textual analysis (e.g., sentiment analysis, topic detection, machine translation); audio analysis (e.g., speech to text, translation, sentiment analysis, wake word detection); system health or diagnostics monitoring; anomaly detection (e.g., fraud detection, detection of medical conditions, prediction of physical or geopolitical events, threat detection). In this embodiment, the present invention can incorporate a process for the purpose of evaluating, by testing the resulting system in cases where the generated features have been applied to the physical environment, the security/safety/resilience of a RNN or other stateful/memory-based machine learning system for the kinds of tasks listed above. Additionally, the invention described herein can enable, by application of the generated features in the physical environment (e.g., by wearing an article of clothing), an object or entity to avoid detection by a RNN or other stateful/memory-based machine learning system for the kinds of tasks listed above.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A system for generating environmental features using deep reinforcement learning, the system comprising:
one or more processors and a non-transitory computer-readable medium having executable instructions encoded thereon such that when executed, the one or more processors perform operations of:
receiving, as input, a policy network architecture, initialization parameters, and a simulation environment that models a trajectory of a target system through a physical environment;
initializing a set of landmark features sampled from the policy network;
generating a trained policy network by training the policy network using a reinforcement learning algorithm;
generating a set of environmental features using the trained policy network; and
displaying the set of environmental features on a display device.

2. The system as set forth in claim 1, wherein the set of environmental features affects performance of a task by a machine learning perception system.

3. The system as set forth in claim 2, wherein the machine learning perception system employs a recurrent neural network (RNN).

4. The system as set forth in claim 2, wherein the task performed is selected from a group consisting of detection, classification, tracking, segmentation, textual analysis, and anomaly detection.

5. The system as set forth in claim 1, wherein the one or more processors further performs an operation of training one or more generative models.

6. The system as set forth in claim 1, wherein the one or more processors further performs an operation of causing physical realization of the set of environmental features by an apparatus.

7. The system as set forth in claim 6, wherein the apparatus is a printer.

8. A computer implemented method for generating environmental features using deep reinforcement learning, the method comprising an act of:
causing one or more processers to execute instructions encoded on a non-transitory computer-readable medium, such that upon execution, the one or more processors perform operations of:
receiving, as input, a policy network architecture, initialization parameters, and a simulation environment that models a trajectory of a target system through a physical environment;
initializing a set of landmark features sampled from the policy network;
generating a trained policy network by training the policy network using a reinforcement learning algorithm;
generating a set of environmental features using the trained policy network; and
displaying the set of environmental features on a display device.

9. The method as set forth in claim 8, wherein the set of environmental features affects the performance of a task by a machine learning perception system.

10. The method as set forth in claim 9, wherein the machine learning perception system employs a recurrent neural network (RNN).

11. The method as set forth in claim 8, wherein the one or more processors further performs an operation of training one or more generative models.

12. The method as set forth in claim 9, wherein the task performed is selected from a group consisting of detection, classification, tracking, segmentation, textual analysis, and anomaly detection.

13. The method as set forth in claim 8, wherein the one or more processors further performs an operation of causing physical realization of the set of environmental features by an apparatus.

14. A computer program product for generating environmental features using deep reinforcement learning, the computer program product comprising:
computer-readable instructions stored on a non-transitory computer-readable medium that are executable by a computer having one or more processors for causing the processor to perform operations of:
receiving, as input, a policy network architecture, initialization parameters, and a simulation environment that models a trajectory of a target system through a physical environment;
initializing a set of landmark features sampled from the policy network;
generating a trained policy network by training the policy network using a reinforcement learning algorithm;
generating a set of environmental features using the trained policy network; and
displaying the set of environmental features on a display device.

15. The computer program product as set forth in claim 14, wherein the set of environmental features affects performance of a task by a machine learning perception system.

16. The computer program product as set forth in claim 15, wherein the machine learning perception system employs a recurrent neural network (RNN).

17. The computer program product as set forth in claim 14, further comprising instructions for causing the one or more processors to further perform an operation of training one or more generative models.

18. The computer program product as set forth in claim 15, wherein the task performed is selected from a group consisting of detection, classification, tracking, segmentation, textual analysis, and anomaly detection.

19. The system as set forth in claim 1, wherein the target system is an autonomous vehicle.
